(19) United States
(12) Patent Application Publication
(10) Pub. No.: US 2026/0079106 A1
(43) Pub. Date: Mar. 19, 2026

(54) OPTICAL INSPECTION APPARATUS AND OPTICAL INSPECTION SYSTEM

(71) Applicant: KABUSHIKI KAISHA TOSHIBA, Kawasaki-shi (JP)

(72) Inventors: Hiroshi OHNO, Tokyo (JP); Hiroya KANO, Kawasaki Kanagawa (JP); Kenta TAKANASHI, Kawasaki Kanagawa (JP)

(73) Assignee: KABUSHIKI KAISHA TOSHIBA, Kawasaki-shi (JP)

(21) Appl. No.: 19/313,948

(22) Filed: Aug. 29, 2025

(30) Foreign Application Priority Data
Sep. 18, 2024 (JP) 2024-161389

(51) Int. Cl. G01N 21/47

(52) U.S. Cl. CPC G01N 21/4795; G01N 2021/4711; G01N 2201/068

(57) ABSTRACT

According to an embodiment, an optical inspection apparatus includes: an image-forming optical element with an imaging optical axis; an image sensor having a light-receiving surface; and a movable first light selection aperture that is arranged on or near a focal plane of the image-forming optical element. The first light selection aperture includes a first light selection region and a second light selection region that selectively pass light in different directions from an object. When the first light selection region moves to a position, the image sensor acquires a first image of the object incident on the light-receiving surface through the image-forming optical element and the first light selection region. When the second light selection region moves to a position, the image sensor acquires a second image of the object incident on the light-receiving surface through the image-forming optical element and the second light selection region.

### CROSS-REFERENCE TO RELATED APPLICATIONS

This application is based upon and claims the benefit of priority from Japanese Patent Application No. 2024-161389, filed Sep. 18, 2024, the entire contents of all of which are incorporated herein by reference.

### FIELD

Embodiments described herein relate generally to an optical inspection apparatus and an optical inspection system.

### BACKGROUND

Contactless inspections of objects have become important in various industries. As a conventional inspection method, there is a method by which a color (wavelength spectrum) of a light beam dispersed using a diffraction grating or a wavelength filter is made to correspond to a light beam direction on a one-to-one basis, the color is specified to identify the direction of the light beam, and information on the surface or inside of the object is acquired.

### BRIEF DESCRIPTION OF DRAWINGS

FIG. 1 is a schematic view of an optical inspection system according to a first embodiment.

FIG. 2 is a schematic diagram illustrating a state in which an intersection position between a first light selection aperture and an optical axis of the optical inspection system illustrated in FIG. 1 is moved to a second light selection region.

FIG. 3 is a schematic block diagram of the optical inspection system according to the first embodiment.

FIG. 4 is a flowchart for performing an optical inspection using the optical inspection system according to the first embodiment.

FIG. 5 is a schematic view corresponding to FIG. 1, illustrating an optical inspection system according to a first modification of the first embodiment.

FIG. 6 is a schematic view corresponding to FIG. 2, illustrating an optical inspection system according to a first modification of the first embodiment.

FIG. 7 is a schematic view of a first light selection aperture of an optical inspection system according to a second modification of the first embodiment.

FIG. 8 is a schematic view of a first light selection aperture of an optical inspection system according to a third modification of the first embodiment.

FIG. 9 is a schematic view of a first light selection aperture and a second light selection aperture of an optical inspection apparatus in an optical inspection system according to a second embodiment.

FIG. 10 is a schematic cross-sectional view taken along an xz plane in FIG. 9.

FIG. 11 is a schematic diagram illustrating a state in which the first light selection aperture and the second light selection aperture illustrated in FIG. 9 are rotated about their respective rotation axes.

FIG. 12 is a schematic diagram illustrating a state in which the first light selection aperture illustrated in FIG. 9 is rotated about the rotation axes of the first light selection aperture.

FIG. 13 is an enlarged view of an opening edge of the first light selection aperture in FIG. 10.

FIG. 14 is an enlarged view of an opening edge of the first light selection aperture in FIG. 10.

FIG. 15 is a schematic block diagram of the optical inspection system according to the second embodiment.

FIG. 16 is a schematic view of a first light selection aperture and a second light selection aperture of an optical inspection apparatus in an optical inspection system according to a modification of the second embodiment.

FIG. 17 is a schematic cross-sectional view taken along an xz plane in FIG. 16.

### DETAILED DESCRIPTION

Hereinafter, embodiments of the present embodiment will be described with reference to the drawings. The drawings are schematic or conceptual, and the relationship between the thickness and width of each portion, the ratio of sizes between portions, and the like are not necessarily the same as actual ones. In addition, even in the case of representing the same portions, their dimensions and ratios may be represented differently from each other in the drawings. In the present specification and each drawing, the same elements as those described above with respect to the previously described drawings are denoted by the same reference numerals, and detailed description thereof is omitted as appropriate.

In the present specification, light is a type of electromagnetic wave, and includes gamma rays, X-rays, ultraviolet rays, visible light, infrared rays, radio waves, and the like. In the present embodiment, light is visible light, and the wavelength is in a region of 400 nm to 750 nm, for example.

An object of an embodiment is to provide an optical inspection apparatus and an optical inspection system including the optical inspection apparatus, capable of acquiring a plurality of images according to a direction of a light beam from an object.

According to the embodiment, an optical inspection apparatus includes: an image-forming optical element with an imaging optical axis; an image sensor having a light-receiving surface intersecting with the imaging optical axis; and a movable first light selection aperture. The first light selection aperture includes a first light selection region and a second light selection region that selectively pass light in different directions from an object. The first light selection aperture is arranged on or near a focal plane of the image-forming optical element. When the first light selection region of the first light selection aperture moves to a position including the imaging optical axis, the image sensor is configured to acquire a first image of the object incident on the light-receiving surface through the image-forming optical element and the first light selection region. When the second light selection region of the first light selection aperture moves to a position including the imaging optical axis, the image sensor is configured to acquire a second image of the object incident on the light-receiving surface through the image-forming optical element and the second light selection region.

### First Embodiment

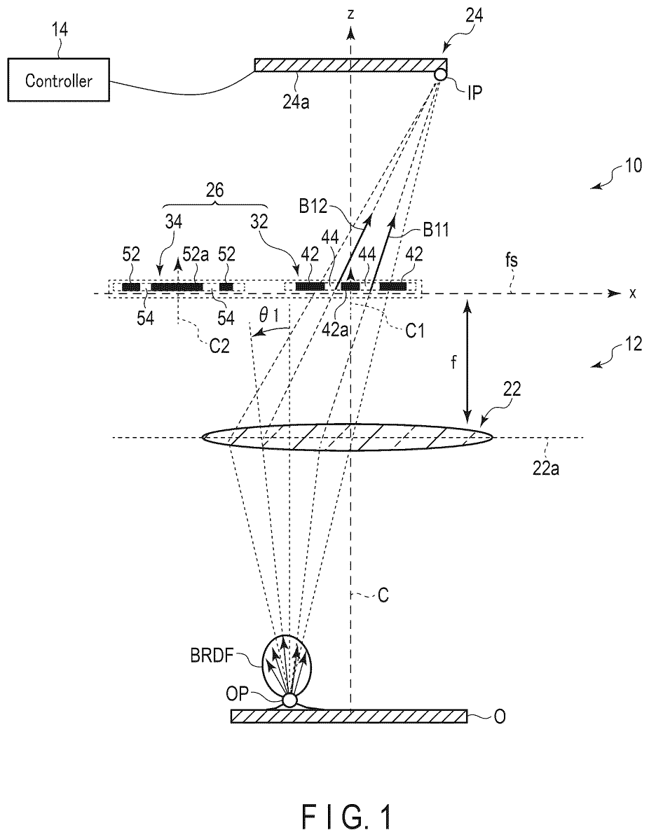

Hereinafter, an optical inspection system 10 according to the present embodiment will be described with reference to FIGS. 1 to 4.

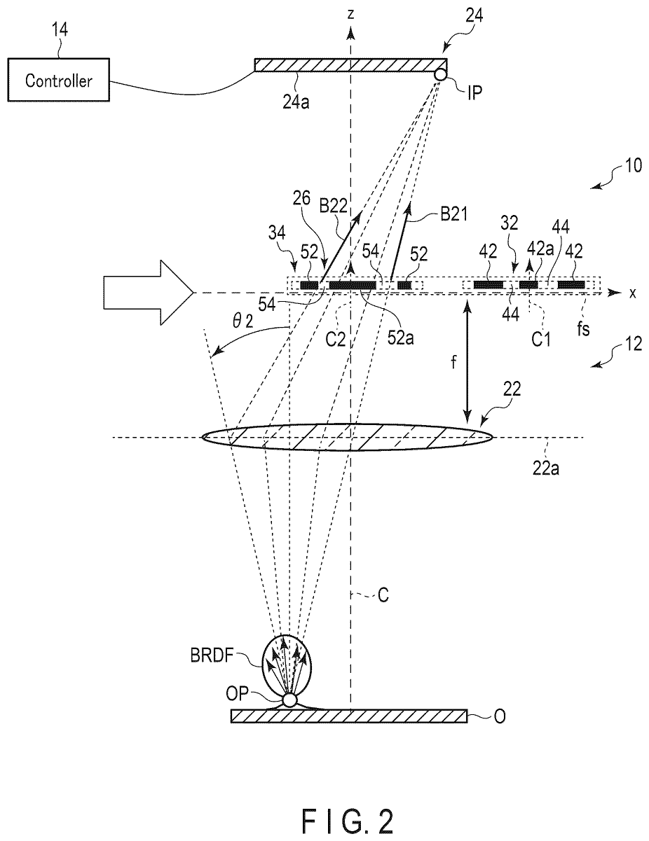

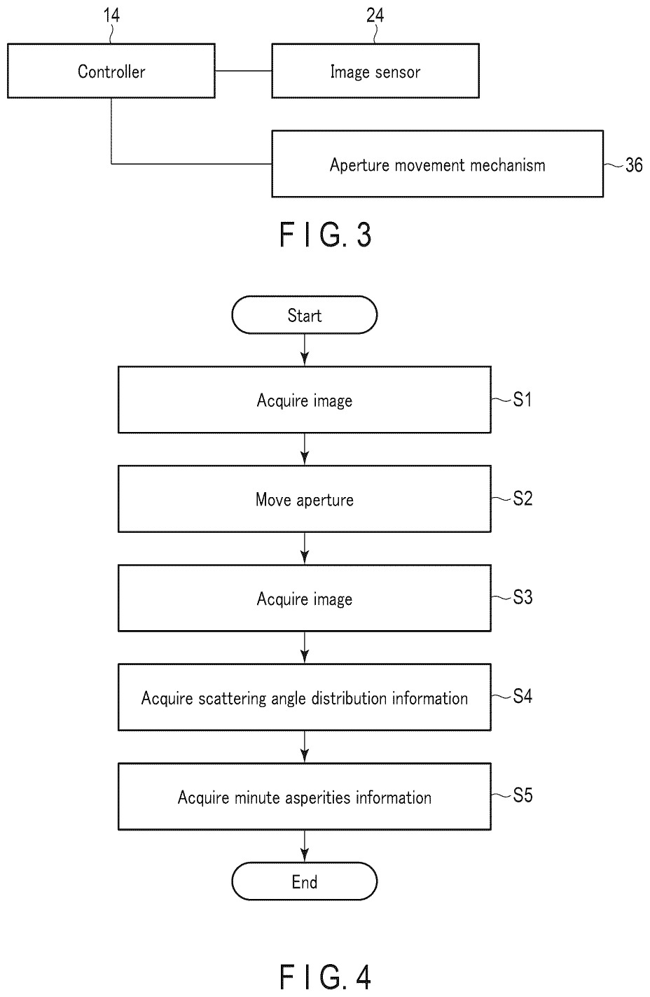

FIGS. 1 and 2 are schematic cross-sectional views of the optical inspection system 10 according to the present embodiment. FIG. 3 is a schematic block diagram of the optical inspection system 10. FIGS. 1 and 2 differ in the position of a first light selection aperture 26, but are otherwise identical.

The optical inspection system 10 includes an optical inspection apparatus 12 and a controller 14. In the present embodiment, the optical inspection apparatus 12 includes an imaging portion 20 that images light incident from an object O along a z axis.

The imaging portion 20 includes an image-forming optical element 22, an image sensor 24, and a first light selection aperture 26.

The image-forming optical element 22 can form an image of light from the object O. The image-forming optical element 22 may be, for example, a single lens, a set lens including a plurality of lenses, a concave mirror, a Fresnel lens, a diffraction grating, a gradient index lens (GRIN lens), or the like. That is, the image-forming optical element 22 may be any element as long as it can form an image of light. A surface on which a set of points at infinity is imaged by the image-forming optical element 22 will be defined as a focal plane fs. The focal plane fs and its vicinity will be called a focal plane region. An optical axis C of the image-forming optical element 22 is a straight line orthogonal to the focal plane fs. Light emitted from a sufficiently distant point on the optical axis C is imaged at a point where the optical axis C and the focal plane fs intersect. This point is referred to as a focal point.

The image-forming optical element 22 has a main surface 22a geometrically determined. A distance defined by the focal plane fs of the image-forming optical element 22 and the main surface 22a closest to the focal plane fs is a focal length f of the image-forming optical element.

The main surface 22a and the focal plane 22 fs of the image-forming optical element are parallel to an xy plane orthogonal to the z axis. A y axis is orthogonal to the x axis.

The image-forming optical element 22 of the present embodiment is a set lens including a plurality of lenses. This is referred here to as an image-forming lens. However, FIG. 1 schematically illustrates the image-forming lens 22 which is a set lens, as one lens, for the sake of simplicity. The image-forming optical element 22 is not limited to this, and may be any element as long as it forms an image of light. In the cross-sectional views (xz cross section) of FIGS. 1 and 2, the optical axis C of the image-forming optical element 22 is included in this cross section. In the cross-sectional views (xz cross section) of FIGS. 1 and 2, the optical axis C of the image-forming optical element 22 coincides with the z axis.

In particular, the image-forming optical element 22 provided in the imaging portion 20 may also be referred to as an image-forming optical element for imaging. The optical axis C of the image-forming optical element for imaging 22 is referred to as an imaging optical axis.

The image sensor 24 can be an appropriate area sensor. The image sensor 24 has a light-receiving surface 24a intersecting with the imaging optical axis C of the image-forming optical element 22, and acquires light incident on the light-receiving surface 24a as an image.

The first light selection aperture 26 is disposed on or near the focal plane fs of the image-forming optical element 22. The first light selection aperture 26 has two different light selection regions, that is, a first light selection region 32 and a second light selection region 34, and an aperture movement mechanism 36.

The first light selection region 32 passes incident light while changing (altering) the characteristics of the light, or passes incident light without changing (altering) the characteristics of the light. The optical characteristics here are the direction, wavelength, wavelength spectrum, polarization, luminance, illuminance, and light flux (light amount) of the incident light beam. The second light selection region 34 passes incident light while changing (altering) the characteristics of the light, or passes incident light without changing (altering) the characteristics of the light. The first light selection region 32 and the second light selection region 34 may block some light. That is, passing the incident light while changing (altering) the characteristics of the incident light through the first light selection region 32 and the second light selection region 34 includes blocking the incident light.

In the present embodiment, the first light selection region 32 and the second light selection region 34 are each formed as a region in which a plurality of light blocking regions and a plurality of light passing regions are arranged adjacent to each other along the x-axis direction, for example.

In the present embodiment, the relative positional relationship between the first light selection region 32 and the second light selection region 34 of the first light selection aperture 26 does not change.

The aperture movement mechanism 36 can move the first light selection region 32 and the second light selection region 34 in the x-axis direction along the focal plane fs, for example. The aperture movement mechanism 36 uses a motor or the like as a drive source controlled by the controller 14, for example, and controls the position of the first light selection region 32 intersecting the optical axis C of the image-forming optical element 22 and the position of the second light selection region 34 in combination with ball screws or the like. As the drive source, a stepping motor is preferably used, but a servo motor or a linear drive mechanism may be used. That is, the drive source may be anything that can change the position of the first light selection region 32 and the position of the second light selection region 34.

In the present embodiment, as an example, both the first light selection region 32 and the second light selection region 34 appear in the cross sections illustrated in FIGS. 1 and 2. For example, the first light selection aperture 26 may be movably provided such that when the first light selection region 32 appears on the cross section in FIG. 1, the second light selection region 34 does not appear on this cross section.

Similarly, the first light selection aperture 26 may be movably provided such that when the second light selection region 34 appears on the cross section in FIG. 2, the first light selection region 32 does not appear on this cross section.

The object O may transmit or reflect light. Alternatively, the object O may be translucent. A point on the surface of the object O or inside the object is referred to as an object point OP. Hereinafter, unless otherwise specified, the object O reflects light, and the object point OP is on the surface of the object O. The surface of the object O may be referred to as an object surface or an object surface.

In the present embodiment, the first light selection region 32 includes a light blocking region 42 that blocks light and a passing region (through-hole) 44 that transmits light. In the cross section illustrated in FIG. 1, the first light selection region 32 is preferably symmetric with respect to the optical axis C, but is not limited to this. The passing region 44 can be considered as a light transmission region that transmits light. In the present embodiment, the through-hole 44 is formed as the light passing region.

For example, three light blocking regions 42 are arranged apart from each other in the x-axis direction. The passing region 44 is formed between the light blocking regions 42. The relative positional relationship between the light blocking region 42 and the passing region 44 is fixed.

In FIG. 1, the optical axis C intersects with the middle light blocking region 42 among the three arranged light blocking regions 42. The middle light blocking region 42 in FIG. 1 may be referred to as a region 42a including a first central axis C1. The first central axis C1 is a virtual axis that is located at the center with respect to the x-axis direction in the region 42a and is parallel to the z-axis direction.

When the light blocking region 42a including the first central axis C1 of the first light selection region 32 coincides with the imaging optical axis C of the image-forming optical element 22, among the light beams from the object O, light beams B11 and B12 forming a first angle θ1 (which is not limited to one angle but refers to an angle within an appropriate range) with respect to the optical axis C pass through the first light selection region 32.

The second light selection region 34 has a light blocking region 52 that blocks light and a passing region (through-holes 54 that passes light. In the cross section illustrated in FIG. 2, the second light selection region 34 is preferably symmetric with respect to the optical axis C, but is not limited to this. The passing region 54 can be considered as a light transmission region that transmits light. In the present embodiment, the through-hole 54 is formed as a light passing region.

For example, three light blocking regions 52 are arranged in the x-axis direction. The passing regions 54 are formed between the light blocking regions 52. The relative positional relationship between the light blocking region 52 and the passing region 54 is fixed.

In FIG. 2, the optical axis C intersects with the middle light blocking region 52 among the three arranged light blocking regions 52. The middle light blocking region 52 in FIG. 2 may be referred to as a region 52a including a second central axis C2. The second central axis C2 is a virtual axis that is located at the center with respect to the x-axis direction in the region 52a and is parallel to the z-axis direction.

The light blocking region 42a including the first central axis C1 of the first light selection region 32 is different in size along the x-axis direction from the light blocking region 52a including the second central axis C2 of the second light selection region 34. In the present embodiment, the light blocking region 42a including the first central axis C1 of the first light selection region 32 is formed to be smaller than the light blocking region 52a including the second central axis C2 of the second light selection region 34.

When the second central axis C2 of the second light selection region 34 coincides with the imaging optical axis C of the image-forming optical element 22, among the light beams from the object O, light beams B21 and B22 forming a second angle θ2 (which is not limited to one angle but refers to an angle within an appropriate range) with respect to the optical axis C pass through the second light selection region 34.

It is assumed that the first angle θ1 is an angle in a range of a first maximum angle θ1M or less and a first minimum angle θ1m or more, and the second angle θ2 is an angle in a range of a second maximum angle θ2M or less and a first minimum angle θ2m or more. In FIG. 1, for example, at least one of a relationship of θ1M <θ2M <90° and a relationship of 0°<01m<θ2m is satisfied. Both relationships may be satisfied. For example, a relationship of θ1M≤θ2m is satisfied.

The controller 14 controls the image sensor 24 and the aperture movement mechanism 36. The controller 14 can also perform various calculations.

The controller 14 is a computer, for example. The controller 14 includes a processor or an integrated circuit (control circuit) including a central processing unit (CPU), an application specific integrated circuit (ASIC), a field programmable gate array (FPGA), or the like, and a storage medium such as a memory. One or more processors or integrated circuits may be provided in the controller 14. The controller 14 executes a process by executing a program or the like stored in a storage medium or the like. For example, an example of the program is an imaging program of the object P. Another example of the program is a control program of the aperture movement mechanism 36.

In the controller 14, the program executed by the processor or the like may be stored in a computer (server) connected via a network such as the Internet, a server in a cloud environment, or the like. In this case, the controller 14 downloads the program via the network. That is, the optical inspection system 10 is preferably controlled by a remote server.

Next, the operation of the optical inspection system 10 according to the present embodiment will be described with reference to FIG. 4.

Although the following processing is mainly performed by the controller 14, the processing may be performed by a processor or may be performed by a server, for example.

The controller 14 controls the aperture movement mechanism 36 to make the first central axis C1 of the first light selection region 32 coincide with the imaging optical axis C of the image-forming optical element 22 as illustrated in FIG. 1. At this time, among the light beams from the object O, the light beams B11 and B12 forming the first angle θ1 (which is not limited to one angle but refers to an angle within an appropriate range) with respect to the optical axis C pass between the light blocking regions 42 of the first light selection region 32, that is, pass through the passing regions 44. On the other hand, the light beams B21 and B22 (see FIG. 2) forming the second angle θ2 (which is not limited to one angle but refers to an angle within an appropriate range) different from the first angle θ1 with respect to the optical axis C are blocked by the light blocking regions 42 of the first light selection region 32. Accordingly, the light beams B11 and B12 forming the first angle θ1 among the light beams from each object point OP on the object surface are imaged at a (conjugate) image point IP corresponding to the object point OP by the image-forming optical element 22 of the imaging portion 20. That is, the object surface is captured as a first image by the image sensor 24 via the group of the light beams B11 and B12 forming the first angle θ1. The controller 14 acquires the first image captured in this manner (step S1).

The controller 14 controls the aperture movement mechanism 36 to make the light blocking region 52a including the second central axis C2 of the second light selection region 34 coincide with the imaging optical axis C of the image-forming optical element 22 as illustrated in FIG. 2 (step S2). At this time, among the light beams from the object O, the light beams B21 and B22 forming the second angle θ2 with respect to the optical axis C pass between the light blocking regions 52 of the second light selection region 34, that is, pass through the passing regions 54. On the other hand, the light beams B11 and B12 forming the first angle θ1 with respect to the optical axis C are blocked by the light blocking regions 52 of the second light selection region 34. Accordingly, the light beams B21 and B22 forming the second angle θ2 among the light beams from each object point OP on the object surface are imaged at a (conjugate) image point IP corresponding to the object point OP by the image-forming optical element 22 of the imaging portion 20. That is, the object surface is captured as a second image by the image sensor 24 via the group of the light beams B21 and B22 forming the second angle θ2. The controller 14 acquires the second image captured in this manner (step S3). As above, the optical inspection system 10 acquires a plurality of different images using the first light selection aperture 26 for the same object surface.

Therefore, the optical inspection apparatus 12 according to the present embodiment can acquire a plurality of images according to the direction of the light beam from the object O by arranging the light blocking region 42a including the first central axis C1 of the first light selection region 32 of the first light selection aperture 26 and the light blocking region 52a including the second central axis C2 of the second light selection region 34 while switching them to the state of intersection with the optical axis C.

Therefore, according to the present embodiment, it is possible to provide the optical inspection apparatus 12 capable of acquiring a plurality of images according to the direction of the light beam from the object O, and the optical inspection system 10 including the optical inspection apparatus 12.

The first image provides intensity information of the light beams B11, B12 forming the first angle θ1 of each object point OP on the object surface. The second image provides intensity information of the light beams B21, B22 forming the second angle θ2 of each object point OP on the object surface. That is, the controller 14 can obtain the intensity information of the light beams B11, B12, B21, and B22 regarding the first angle θ1 and the second angle θ2 from the first image and the second image. That is, the controller 14 can obtain information on the scattering angle distribution of each object point OP on the object O (step S4). In particular, if the object O is reflective, information on the scattering angle distribution can be expressed by bidirectional reflectance direction function (BRDF).

If the controller 14 obtains the information on the scattering angle distribution, the controller 14 can obtain information on the minute asperities on the object surface (step S5). For example, reflection of light on a flat object surface becomes specular reflection, and the scattering angle distribution becomes narrow. On the other hand, if minute asperities are present on the object surface, the scattering angle distribution is generally wide. Therefore, according to the optical inspection system 10 in the present embodiment, since the controller 14 can perform appropriate calculation based on the image captured by the optical inspection apparatus 12 to obtain information on the scattering angle distribution, there is an advantageous effect that the presence or absence of minute asperities can be detected.

On the other hand, in a case where the optical inspection system 10 uses either the first image or the second image, only either the light intensity related to the first angle θ1 or the light intensity related to the second angle θ2 can be obtained. At this time, the controller 14 cannot obtain information on the spread of the scattering angle distribution. Therefore, it is difficult for the optical inspection system 10 to detect the presence or absence of minute asperities.

In the present embodiment, the region 42a including the first central axis C1 of the first light selection region 32 is set as a blocking region, and the region 52a including the second central axis C2 of the second light selection region 34 is set as a blocking region. For example, the region including the first central axis C1 of the first light selection region 32 may be formed not as a blocking region but as a transmission region that transmits light. That is, in the first light selection region 32 illustrated in FIG. 1, the blocking region and the passing region may be interchanged. Similarly, the region including the second central axis C2 of the second light selection region 34 may be formed not as a blocking region but as a transmission region that transmits light.

That is, in the second light selection region 34 illustrated in FIG. 2, the blocking region and the passing region may be interchanged.

In the present embodiment, an example has been described in which the first light selection region 32 and the second light selection region 34 of the first light selection aperture 26 are moved to intersect with the optical axis C using the aperture movement mechanism 36. For example, the first light selection region 32 and the second light selection region 34 of the first light selection aperture 26 may be manually moved with respect to the optical axis C.

### First Modification

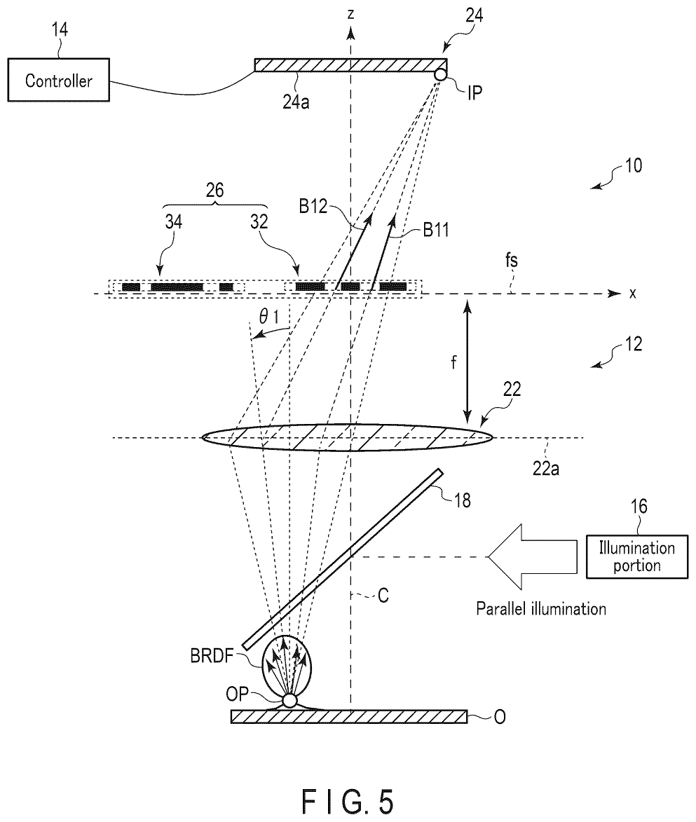

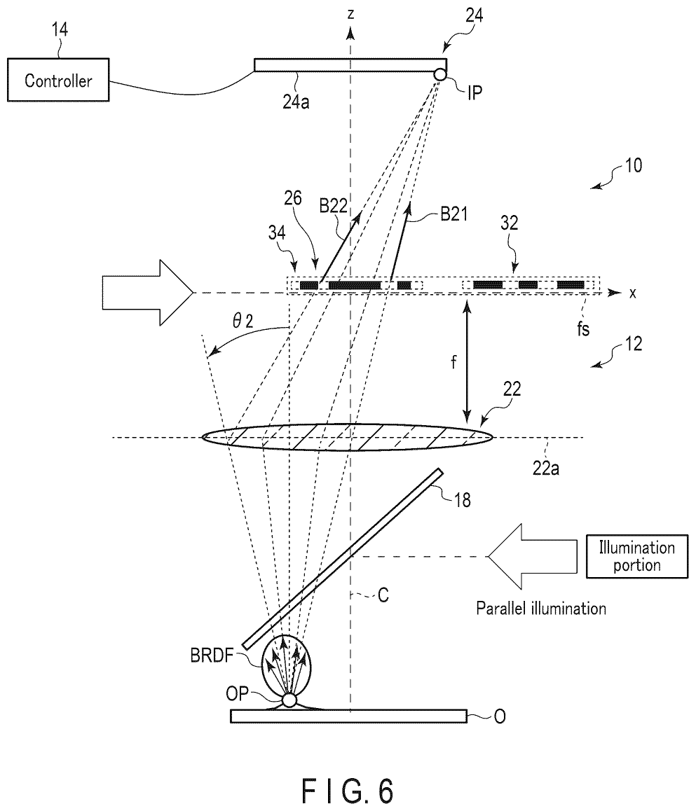

A first modification of the optical inspection system 10 according to the present embodiment will be described. FIGS. 5 and 6 illustrate an optical inspection system 10 according to the first modification.

Referring to FIG. 5, an illumination portion 16 and a beam splitter 18 are added to the optical inspection apparatus 12 of the optical inspection system 10 illustrated in FIG. 1, and referring to FIG. 6 an illumination portion 16 and a beam splitter 18 are added to the optical inspection apparatus 12 of the optical inspection system 10 illustrated in FIG. 2.

Therefore, the optical inspection system 10 according to the first modification further includes the illumination portion 16 and the beam splitter 18 in addition to an optical inspection apparatus 12 and a controller 14.

The illumination portion 16 includes a light source, and the light source may be a white light source or a white light-emitting diode (LED), for example. However, the light source is not limited to this example, and any light source may be used as long as it emits light. The light source may be a laser diode (LD). Alternatively, the light source may be sunlight, a plasma light source, a thermal radiation light source (incandescent lamp, halogen lamp, xenon lamp, or the like), or the like.

In the light source of the illumination portion 16, on/off of light emission is preferably controlled by the controller 14. When the controller 14 turns on the light source of the illumination portion 16 to irradiate the object surface with illumination light from the light source, the controller 14 controls an image sensor 24 to acquire an image.

The beam splitter 18 is provided between the object O and the image-forming optical element 22. The beam splitter 18 intersects with the optical axis C of the image-forming optical element 22.

The controller 14 emits illumination light from the illumination portion 16 as parallel illumination light. The beam splitter 18 makes the illumination light from the illumination portion 16 parallel to the imaging optical axis C of the image-forming optical element 22 so as to reach the object surface. The beam splitter 18 here may be unpolarized or may have polarizability.

Therefore, the illumination portion 16 can emit parallel illumination light to the object O along the imaging optical axis C. Then, as described in the first embodiment, the controller 14 acquires a first image by the image sensor 24 when a first light selection region 32 is arranged on the optical axis C, and acquires a second image by the image sensor 24 when a second light selection region 34 is arranged on the optical axis C. As above, the optical inspection system 10 acquires a plurality of different images using the first light selection aperture 26 for the same object surface.

According to the present modification, all the directions of the light beams incident on each object point OP of the object O can be aligned. Therefore, as compared with the case where the directions of light beams incident on each object point OP are different, it is possible to reduce changes in the scattering angle distribution obtained from the first image and the second image depending on the directions of the incident light beams. In addition, using parallel illumination light makes more remarkable the spread of the scattering angle distribution due to minute asperities obtained from the first image and the second image, as compared with the case of using illumination light at a divergence angle. That is, using parallel illumination light in the first modification has an advantageous effect that the controller 14 can optically inspect the surface state of the object O with higher accuracy, as compared with the case where the directions of the light beams incident on the object point OP are different.

In both the example illustrated in FIG. 5 and the example illustrated in FIG. 6, if the object point OP is formed to be specular by using parallel illumination as the illumination, for example, a light blocking region 42a including a first central axis C1 and a light blocking region 52a including a second central axis C2 prevent the light beam from entering a light-receiving surface 24a of the image sensor 24. Therefore, the controller 14 can also inspect the surface state of the object O by detecting the presence or absence of incident light.

### Second Modification

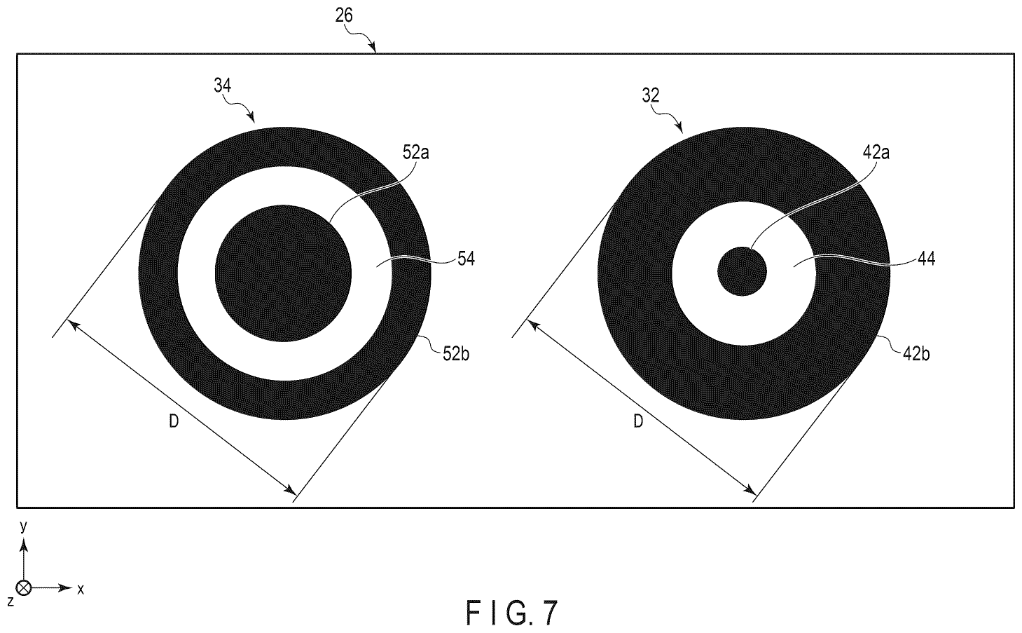

An example of a first light selection aperture 26 may be that illustrated in FIG. 7. The first light selection aperture 26 illustrated in FIG. 7 is parallel to an xy plane (focal plane fs).

As illustrated in FIG. 7, the outer diameters of a first light selection region 32 and a second light selection region 34 are formed to have the same size D, for example.

The first light selection region 32 has a circular central light blocking region 42a including a first central axis C1 (see FIGS. 1 and 2) in the central part, and has an outer peripheral light blocking region 42b concentrically on the outer periphery of the central light blocking region 42a. A region between the central light blocking region 42a and the outer peripheral light blocking region 42b is formed as a passing region 44 that has an annular space, a transparent film, a transparent plate, or the like and passes light beams (in the first embodiment, reference numerals B11 and B12 (see FIG. 1)).

In the example of the optical inspection apparatus 12 illustrated in FIG. 1, the first light selection region 32 of the first light selection aperture 26 is preferably arranged such that the center (first central axis C1) of the central light blocking region 42a illustrated in FIG. 7 coincides or substantially coincides with the optical axis C.

The second light selection region 34 has a circular central light blocking region 52a including a second central axis C2 (see FIGS. 1 and 2) in the central part, and has an outer peripheral light blocking region 52b concentrically on the outer periphery of the central light blocking region 52a. A region between the central light blocking region 52a and the outer peripheral light blocking region 52b is formed as a passing region 54 through which a light beam (In the first embodiment, reference numerals B21 and B22 (see FIG. 2)) passes by an annular space, a transparent film, a transparent plate, or the like.

In the example of the optical inspection apparatus 12 illustrated in FIG. 2, the second light selection region 34 of the first light selection aperture 26 is preferably arranged such that the center (second central axis C2) of the central light blocking region 52a illustrated in FIG. 7 coincides or substantially coincides with the optical axis C.

For example, the central light blocking region 42a along the radial direction of the first light selection region 32 has a blocking region formed to be smaller than a blocking region of the central light blocking region 52a along the radial direction of the second light selection region 34. The outer peripheral light blocking region 42b along the radial direction of the first light selection region 32 has the same outer diameter as the outer peripheral light blocking region 52b along the radial direction of the second light selection region 34, but has a thick circular ring and a large blocking region.

The passing regions 44 and 54 may pass light beams having appropriate wavelength spectra and block light beams having other wavelength spectra.

The light blocking region 42 and the passing region 44 of the first light selection region 32 illustrated in FIG. 7 may be interchanged. Similarly, in the second light selection region 34 illustrated in FIG. 7, the light blocking region 52 and the passing region 54 may be interchanged. The first light selection region 32 and the second light selection region 34 may have any blocking region and passing region interchanged.

### Third Modification

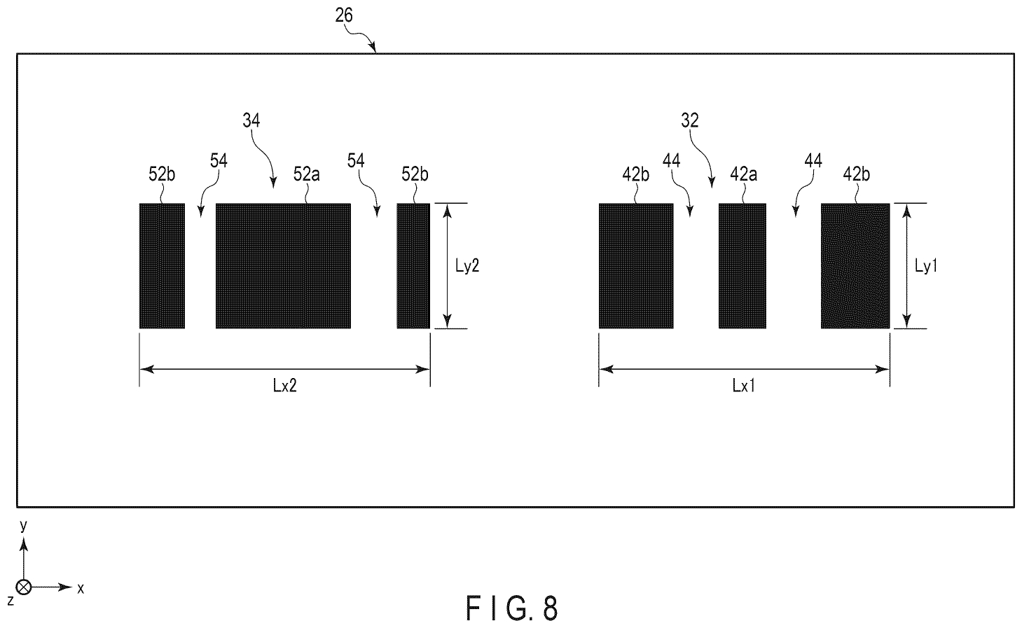

A first light selection aperture 26 may be as illustrated in FIG. 8, for example. The first light selection aperture 26 illustrated in FIG. 8 is parallel to an xy plane (focal plane fs).

As illustrated in FIG. 8, a first light selection region 32 and a second light selection region 34 each have three rectangles arranged in an x-axis direction. A length Lx1 along the x-axis direction of the first light selection region 32 and a length Lx2 along the x-axis direction of the second light selection region 34 are the same, and a length Ly1 along a y-axis direction of the first light selection region 32 and a length Ly2 along the y-axis direction of the second light selection region 34 are the same.

The first light selection region 32 has a central light blocking region 42a including a first central axis C1 (not illustrated) in the middle rectangle along the x-axis direction and a pair of outer light blocking regions 42b outside the middle rectangle. Regions between the central light blocking region 42a and the pair of outer light blocking regions 42b are formed as passing regions 44 that have a space, a transparent film, a transparent plate, or the like and pass light beams (in the first embodiment, reference numerals B11 and B12 (see FIG. 1)).

In the example illustrated in FIG. 1, the first light selection aperture 26 is preferably arranged such that an optical axis C coincides or substantially coincides with the center (first central axis C1) in the x-axis direction (width direction) and the y-axis direction (vertical direction) of the central light blocking region 42a illustrated in FIG. 8.

The second light selection region 34 has a central light blocking region 52a including a second central axis C2 (not illustrated) in the middle rectangle along the x-axis direction and a pair of outer light blocking regions 52b outside the middle rectangle. Regions between the central light blocking region 52a and the pair of outer light blocking regions 52b are formed as passing regions 54 that have a space, a transparent film, a transparent plate, or the like and pass light beams (in the first embodiment, reference numerals B21 and B22 (see FIG. 2)).

In the example illustrated in FIG. 2, the first light selection aperture 26 is preferably arranged such that the optical axis C coincides or substantially coincides with the center in the x-axis direction (width direction) and the center (second central axis C2) in the y-axis direction (vertical direction) of the central light blocking region 52a illustrated in FIG. 8.

For example, the width of the central light blocking region 42a of the first light selection region 32 in the x-axis direction is smaller than the width of the central light blocking region 52a of the second light selection region 34 in the x-axis direction. The pair of outer light blocking regions 42b of the first light selection region 32 has a larger width in the x-axis direction and a larger blocking region than the pair of outer light blocking regions 52b of the second light selection region 34.

The passing regions 44 and 54 may pass light beams having appropriate wavelength spectra and block light beams having other wavelength spectra.

The light blocking regions 42 and the passing regions 44 of the first light selection region 32 illustrated in FIG. 8 may be interchanged. Similarly, in the second light selection region 34 illustrated in FIG. 8, the light blocking regions 52 and the passing regions 54 may be interchanged. The first light selection region 32 and the second light selection region 34 may have any blocking region and passing region interchanged.

### Second Embodiment

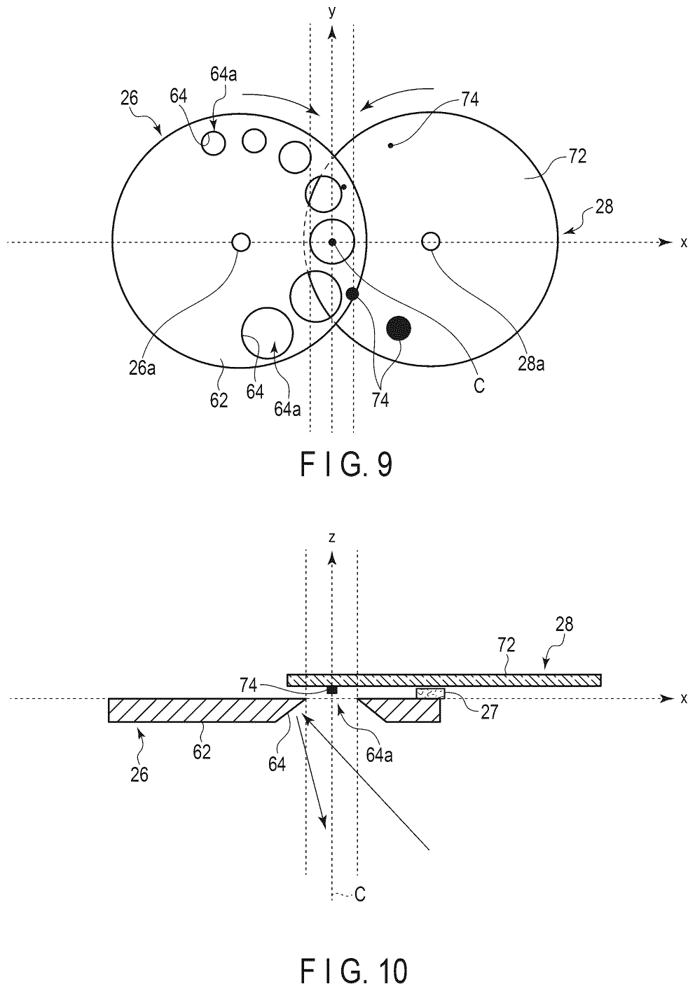

Hereinafter, an optical inspection apparatus 12 of an optical inspection system 10 according to the present embodiment will be described with reference to FIGS. 9 to 15.

A basic structure of the optical inspection apparatus 12 is the same as that of the optical inspection apparatus 12 of the first embodiment (see FIGS. 1 and 2) or the optical inspection apparatus 12 of the first modification (see FIGS. 5 and 6). Here, differences from the first embodiment will be described.

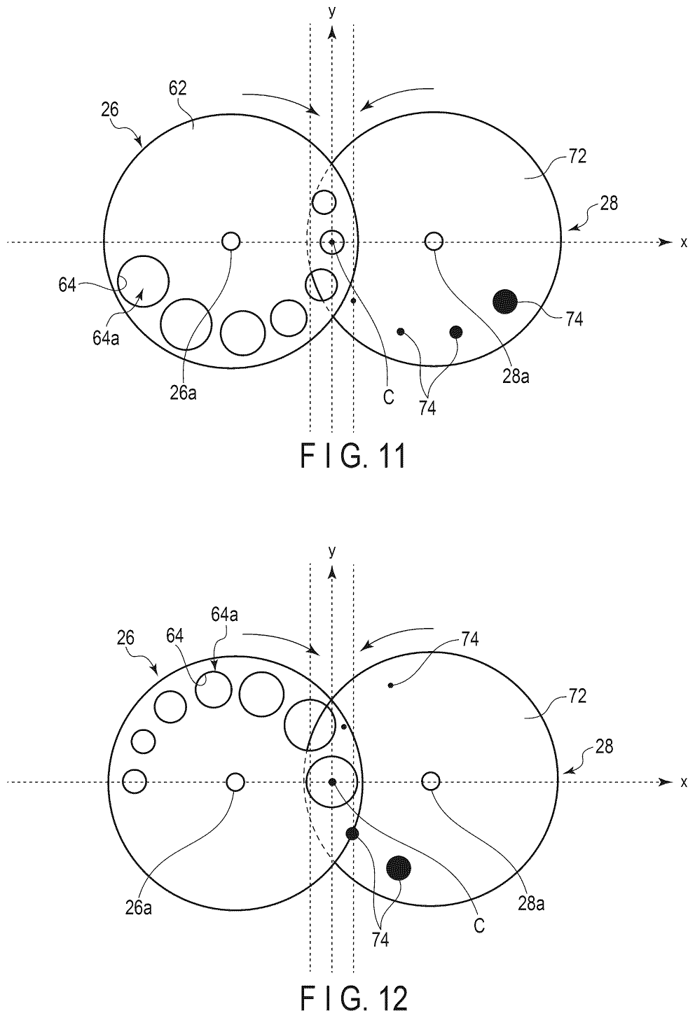

FIGS. 9 and 10 are schematic diagrams of a first light selection aperture 26 and a second light selection aperture 28 of the optical inspection apparatus 12 according to the present embodiment. FIG. 9 is a view of the first light selection aperture 26 and the second light selection aperture 28 as seen from an image-forming optical element 22 side. FIG. 10 is a schematic cross-sectional view taken along an xy plane including an optical axis C of the image-forming optical element 22 in FIG. 9. FIG. 11 is a diagram illustrating a state in which the first light selection aperture 26 and the second light selection aperture 28 illustrated in FIG. 9 are rotated about rotation axes 26a and 28a. FIG. 12 is a diagram illustrating a state in which the first light selection aperture 28 is rotated about the rotation axis 26a while the position of the second light selection aperture 26 illustrated in FIG. 9 is maintained.

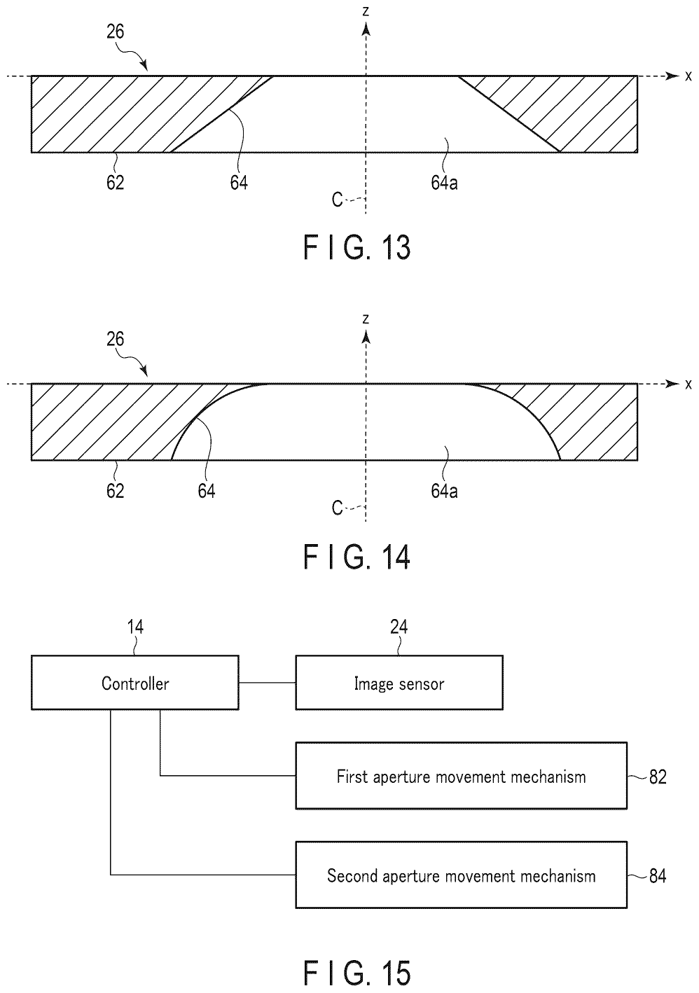

FIG. 13 is an enlarged view of an opening edge 64 of the first light selection aperture 26 in FIG. 10. FIG. 14 is a modification of the opening edge 64 illustrated in FIG. 13.

FIG. 15 is a schematic block diagram of an optical inspection system 10 according to the second embodiment.

In the present embodiment, an imaging portion 20 of the optical inspection apparatus 12 of the optical inspection system 10 includes the image-forming optical element 22, an image sensor 24, the first light selection aperture 26, the second light selection aperture 28, and a spacer 27. FIGS. 9 to 12 illustrate the first light selection aperture 26, the second light selection aperture 28, and the spacer 27, and do not illustrate the image-forming optical element 22 and the image sensor 24.

As illustrated in FIGS. 9 to 12, the first light selection aperture 26 and the second light selection aperture 28 are formed in a disk shape so as to be rotatable about the rotation axes 26a and 28a parallel to a z-axis direction. The rotation axis 26a of the first light selection aperture 26 and the rotation axis 28a of the second light selection aperture 28 are preferably arranged in parallel to a z axis at positions on an x axis shifted from the optical axis C of the image-forming optical element 22. The disks of the first light selection aperture 26 and the second light selection aperture 28 are arranged so as to partially overlap when projected onto a cross-section orthogonal to the optical axis C.

With respect to the first light selection aperture 26, the second light selection aperture 28 is arranged on the image sensor 24 side. In other words, the first light selection aperture 26 is arranged on the image-forming optical element 22 side with respect to the second light selection aperture 28. The spacer 27 for keeping a predetermined spacing is provided between the first light selection aperture 26 and the second light selection aperture 28. The spacer 27 is provided in the first light selection aperture 26, for example, and is made of a material having good slippage with respect to the second light selection aperture 28.

As an example, the first light selection aperture 26 illustrated in FIGS. 9 to 12 is formed as a rigid body having an appropriate thickness. The first light selection aperture 26 is formed of an opaque shielding material. An example of material of the first light selection aperture 26 is a metal material or a resin material.

The first light selection aperture 26 includes a blocking portion 62 and a plurality of opening edges 64 each forming a through-hole 64a.

The blocking portion 62 is formed in a disk shape. The plurality of through-holes 64a is formed as light transmission regions that transmit light. The plurality of through-holes 64a is preferably formed in a substantially circular shape in the blocking portion 62. The plurality of through-holes 64a is formed as circular holes having different diameters. Therefore, the plurality of opening edges 64 is formed as a first-1 light selection region (first light selection region), a first-2 light selection region (second light selection region), a first-3 light selection region, . . . , a first-M light selection region. Therefore, the first light selection aperture 26 has M different light selection regions (M is a natural number of 2 or more), for example.

The center of the through-hole 64a of each opening edge 64 is provided to coincide or substantially coincide with the optical axis C by the rotation axis 26a of the first light selection aperture 26, that is, the rotation of the blocking portion 62. Therefore, the center of each opening edge 64 is equidistant from the rotation axis 26a of the blocking portion 62.

The opening edge 64 has a reverse taper 66 that expands as it goes away from the image sensor 24 toward the object O. In other words, the opening edge 64 has a forward taper 66 that narrows with increasing proximity to the image sensor 24. When the cross section illustrated in FIG. 10 is viewed, the through-hole 64a formed by the opening edge 64 is preferably formed in an isosceles trapezoidal shape in the cross section illustrated in FIG. 13, for example. Therefore, in the cross section illustrated in FIG. 13, the opening edge 64 is preferably formed in a straight line that does not reflect light from the image-forming optical element 22 side or the object O side toward the image sensor 24 side as much as possible but directs the light toward the image-forming optical element 22 side. Alternatively, in the cross section illustrated in FIG. 14, the opening edge 64 is preferably formed in a curved line that does not reflect light from the image-forming optical element 22 side or the object O side toward the image sensor 24 side as much as possible but directs the light toward the image-forming optical element 22 side. The curved line in the cross section of the opening edge 64 is preferably formed so as to be recessed away from the z axis as compared with the example of the straight line in the cross section of the opening edge 64 illustrated in FIG. 13. Therefore, the first light selection aperture 26 has an appropriate thickness, and each opening edge 64 is formed in a shape tapered from the object O side toward the image sensor 24 side as viewed in the xz cross section.

Accordingly, even if an unnecessary light beam among the light beams traveling from the side far from the image sensor 24 toward the image sensor 24 is reflected by the opening edge 64 of the first light selection aperture 26, it is possible to block the light reflected by the opening edge 64 from being incident on the light-receiving surface 24a of the image sensor 24. On the other hand, if the opening edge 64 is not tapered as described above, there is a possibility that the light having reached the side surface may be partially reflected, and the reflected unnecessary light beam may reach the image sensor 24 and be imaged as noise. That is, providing the taper in the opening edge 64 prevents intrusion of noise into the image.

As illustrated in FIGS. 9 to 12, the second light selection aperture 28 includes a light transmission portion 72 and a plurality of light blocking portions (light blocking substance) 74.

The light transmission portion 72 is formed in a disk shape. The light transmission portion 72 is formed of a light transmission plate (transparent material) that transmits light, for example. As the light transmission plate 72, quartz glass having a thickness of about 0.5 mm is preferably used, for example. Both surfaces of the light transmission plate 72 preferably have anti-reflection (AR) coating.

The plurality of light blocking portions 74 that shields light is bonded to the surface of the light transmission plate 72 that is farther from the image sensor 24. The plurality of light blocking portions 74 is provided such that the centers of the plurality of light blocking portions 74 are selectively arranged on the optical axis C of the image-forming optical element 22 with respect to the light transmission plate 72 according to the rotation of the light transmission plate 72 about the rotation axis 26a. The plurality of light blocking portions 74 is formed by chromium vapor deposition or the like, for example. The plurality of light blocking portions 74 preferably absorbs light.

Each light blocking portion 74 is preferably formed in a circular shape. The light blocking portions 74 are formed to have different diameters. Therefore, the plurality of light blocking portions 74 is formed as a second-1 light selection region (third light selection region), a second-2 light selection region (fourth light selection region), a second-3 light selection region, . . . , and a second-N light selection region. For example, the second light selection aperture 28 has N light selection regions (N is a natural number of 2 or more) different from each other, for example.

The diameter of the smallest through-hole 64a is preferably the same as or substantially the same as the diameter of the largest light blocking portion 74.

The first light selection aperture 26 has a first aperture movement mechanism 82, and the second light selection aperture 28 has a second aperture movement mechanism 84. As illustrated in FIG. 15, the first aperture movement mechanism 82 and the second aperture movement mechanism 84 are controlled by the controller 14.

The first aperture movement mechanism 82 according to the present embodiment can independently move the blocking portion 62 of the first light selection aperture 26 around the rotation axis 26a parallel to the imaging optical axis C. The second aperture movement mechanism 84 according to the present embodiment can independently move the light transmission portion 72 of the second light selection aperture 28 around the rotation axis 28a parallel to the imaging optical axis C. The rotation angles of the first aperture movement mechanism 82 and the second aperture movement mechanism 84 are controlled using motors or the like as drive sources controlled by the controller 14, for example. Thus, the controller 14 controls the aperture movement mechanisms 82 and 84 to arrange the respective rotation angles of the blocking portion 62 of the first light selection aperture 26 and the light transmission portion 72 of the second light selection aperture 28 at desired angles. Therefore, the controller 14 selectively arranges the central axes of the plurality of opening edges 64 of the first light selection aperture 26 and the central axes of the plurality of light blocking portions 74 of the second light selection aperture 28 on the optical axis C of the image-forming optical element 22. It is preferable to use stepping motors as drive sources of the first light selection aperture 26 and the second light selection aperture 28, but servo motors may be used instead.

Under the above configuration, the operation of the optical inspection system 10 according to the present embodiment will be described.

The controller 14 of the present embodiment can independently rotate the blocking portion 62 of the first light selection aperture 26 to a desired angle around the rotation axis 26a. The controller 14 can also independently rotate the light transmission portion 72 of the second light selection aperture 28 to a desired angle around the rotation axis 28a. Therefore, as illustrated in FIG. 9, the controller 14 controls the first aperture movement mechanism 82 to move the first-1 light selection region (first light selection region), which is one of the plurality of opening edges 64 of the first light selection aperture 26, and controls the second aperture movement mechanism 84 to move the second-1 light selection region (third light selection region), which is one of the plurality of light blocking portions 74 of the second light selection aperture 28, to positions including the imaging optical axis C at the same time for both regions, for example. At this time, the positional relationship in the z-axis direction between the blocking portion 62 of the first light selection aperture 26 and the light transmission portion 72 of the second light selection aperture 28 is unchanged due to the presence of the spacer 27. Accordingly, various blocking or transmission regions can be formed in the region including the imaging optical axis C of the focal plane fs or in the vicinity thereof. That is, the optical inspection apparatus 12 according to the present embodiment can form various types of light selection regions by adjusting the rotation angles around the rotation axes 26a and 28a of the first light selection aperture 26 and the second light selection aperture 28.

Then, the controller 14 controls the image sensor 24 to capture an image of the object O incident on the light-receiving surface 24a of the image sensor 24 to acquire a third image.

As illustrated in FIG. 11, the controller 14 controls the first aperture movement mechanism 82 to move the first-2 light selection region (second light selection region), which is one of the plurality of opening edges 64 of the first light selection aperture 26, and controls the second aperture movement mechanism 84 to move the second-2 light selection region (fourth light selection region), which is one of the plurality of light blocking portions 74 of the second light selection aperture 28, to positions including the imaging optical axis C at the same time for both regions, for example. Then, the controller 14 controls the image sensor 24 to capture an image of the object O incident on the light-receiving surface 24a of the image sensor 24 to acquire a fourth image. As above, the optical inspection system 10 acquires a plurality of different images using the first light selection aperture 26 for the same object surface.

Therefore, the optical inspection apparatus 12 according to the present embodiment can acquire an image according to the direction of the light beam from the same object O by using, for example, a combination of the first-1 light selection region (first light selection region) of the first light selection aperture 26 and the second-1 light selection region (third light selection region) of the second light selection aperture 28, and a combination of the first-2 light selection region (second light selection region) of the first light selection aperture 26 and the second-2 light selection region (fourth light selection region) of the second light selection aperture 28.

Therefore, according to the present embodiment, it is possible to provide the optical inspection apparatus 12 capable of acquiring a plurality of images according to the direction of the light beam from the object O, and the optical inspection system 10 including the optical inspection apparatus 12.

For example, after acquiring the third image, the controller 14 may acquire a fifth image different from the fourth image. When a combination of the light selection region of the first light selection aperture 26 and the light selection region of the second light selection aperture 28 is different from a combination of the first-1 light selection region (first light selection region) and the second-1 light selection region (third light selection region) and is simultaneously moved to a position including the imaging optical axis C, the controller 14 captures an image of the object O incident on the light-receiving surface 24a of the image sensor 24 and acquires a fifth image. For example, the second light selection aperture 28 illustrated in FIGS. 9 and 12 is arranged at the same position. As illustrated in FIG. 12, the first light selection aperture 26 has been rotated from the position illustrated in FIG. 9. Therefore, after acquiring one image (the third image described above), the optical inspection system 10 may acquire the fifth image by rotating at least one of the first light selection aperture 26 and the second light selection aperture 28.

For example, the first light selection aperture 26 includes M types of light selection regions (through-holes 64a), and the second light selection aperture 28 includes N types of light selection regions (light blocking portions 74). At this time, by adjusting the rotation angles of the first light selection aperture 26 and the second light selection aperture 28 around the rotation axes 26a and 28a, at least N×M types of light selection regions can be formed in the region including the imaging optical axis C of the focal plane fs or in the vicinity thereof. Therefore, the controller 14 can acquire N×M types of images at most by selectively moving the first light selection aperture 26 and the second light selection aperture 28 with respect to a certain object O using the image sensor 24, without moving the image-forming optical element 22 and the image sensor 24. On the other hand, only N or M types of light selection regions can be formed in the first light selection aperture 26 or the second light selection aperture 28. That is, according to the present embodiment, there is an advantageous effect that a dramatically increased number of types of light selection regions can be formed.

As the types of formable light selection regions increase, the angular resolution of the acquirable scattering angle distribution improves. Therefore, using the optical inspection apparatus 12 according to the present embodiment to capture a plurality of images of the object O and processing the images by the controller 14 has an advantageous effect of improving the accuracy of the optical inspection of the object O. Alternatively, using the optical inspection apparatus 12 according to the present embodiment to increase the types of formable light selection regions has an advantageous effect of further optimizing the light selection regions according to the inspection target.

In the optical inspection apparatus 12 according to the present embodiment, N×M types of light selection regions can be formed, for example, by moving the first light selection aperture 26 and the second light selection aperture 28 by the aperture movement mechanism 36, but it is not necessarily required to use all of the light selection regions, and some of them may be used.

The second light selection aperture 28 is formed by the light transmission plate 72 that transmits light, and the light blocking portion 74 that blocks light is bonded to the surface of the light transmission plate 72 far from the image sensor 24. Accordingly, an annular aperture is formed by the through-hole 64a of the first light selection aperture 26 and the light blocking portion 74 of the second light selection aperture 28 at a distance closer to the focal plane fs. On the other hand, if the light blocking portion 74 is formed on the front surface of the light transmission plate 72 closer to the image sensor 24, for example, the light reflected by the light blocking portion 74 toward the side farther from the image sensor 24 is reflected again on the back surface of the light transmission plate 72 to become stray light, and reaches the image sensor 24 to become imaging noise. That is, the present embodiment has an advantageous effect of reducing such noise.

### Modification

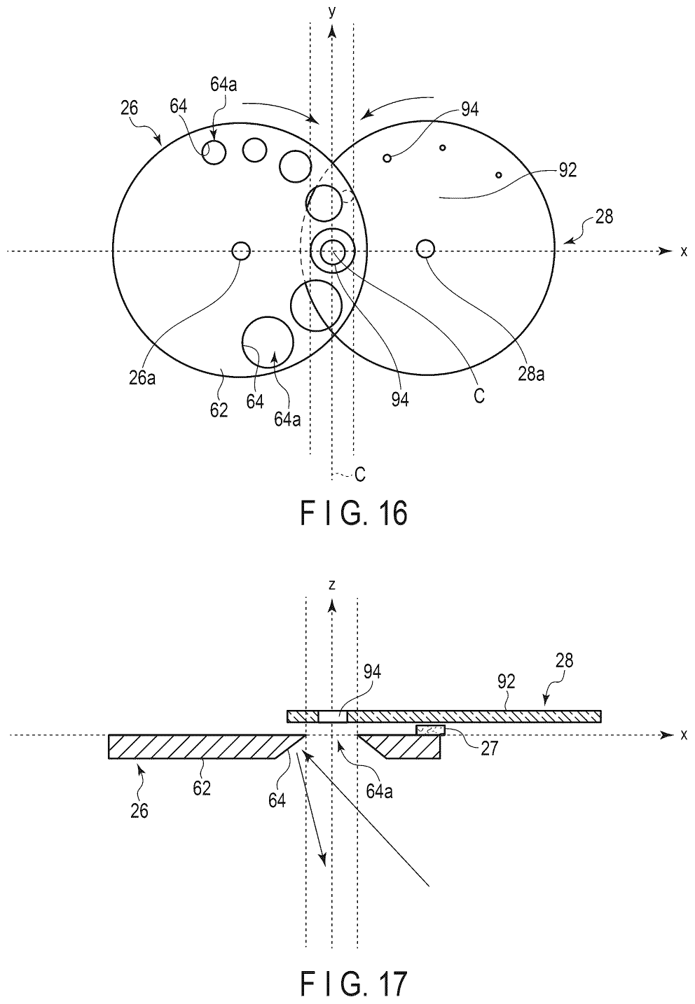

Hereinafter, an optical inspection apparatus 12 according to the present modification will be described with reference to FIGS. 16 and 17.

The basic structure of the optical inspection apparatus 12 according to the present modification is the same as that of the optical inspection apparatus 12 according to the second embodiment. Differences from the optical inspection apparatus 12 according to the second embodiment will be described here.

FIGS. 16 and 17 are schematic diagrams of a first light selection aperture 26 and a second light selection aperture 28 of the optical inspection apparatus 12 according to the present modification. FIG. 16 is a view of the first light selection aperture 26 and the second light selection aperture 28 as seen from an image-forming optical element 22 side. FIG. 17 is a schematic cross-sectional view taken along an xy plane including an optical axis C of the image-forming optical element 22 in FIG. 16.

In the present modification, an imaging portion 20 includes the image-forming optical element 22, an image sensor 24, the first light selection aperture 26, the second light selection aperture 28, and a spacer 27.

The first light selection aperture 26 is formed similarly to the first light selection aperture 26 in the second embodiment.

Similarly to the second light selection aperture 28 in the second embodiment, the second light selection aperture 28 is rotatable about a rotation axis 28a by a second aperture movement mechanism 84.

The second light selection aperture 28 includes a wavelength-selective transmission plate 92 and a plurality of opening edges 94 each forming a through-hole 94a.

The wavelength-selective transmission plate 92 transmits light of a specific wavelength spectrum. The wavelength-selective transmission plate 92 here transmits red light of a wavelength of 500 nm to 700 nm and blocks visible light of other wavelengths, for example. That is, the light having passed through the wavelength-selective transmission plate 92 becomes red light.

The wavelength-selective transmission plate 92 has the through-holes 94a formed therein. The plurality of through-holes 94a is provided in the wavelength-selective transmission plate 92 such that the centers of the plurality of through-holes 94a are selectively arranged on the optical axis C of the image-forming optical element 22 according to the rotation of the wavelength-selective transmission plate 92 about a rotation axis 28a. If the light source emits white light, the light passing through the through-holes 94a is white light including blue light.

The diameter of the smallest through-hole 64a is preferably equal to or substantially equal to the diameter of the largest through-hole 94a. Therefore, the through-holes 94a of the second light selection aperture 28 and the wavelength-selective transmission plate 92 outside the opening edges 94 forming the through-holes 94a are formed as a plurality of transmission wavelength spectrum regions that transmits light of at least two different wavelengths. That is, the second light selection aperture 28 has a plurality of transmission wavelength spectrum regions through which light of at least two different wavelengths is transmitted.

In each pixel, the image sensor 24 independently receives at least red light of a wavelength of 500 nm to 700 nm and blue light with a wavelength different from the red light and with a peak wavelength of 450 nm. In each pixel, a channel for receiving red light is R, and a channel for receiving blue light is B.

Under the above configuration, the operation of an optical inspection system 10 according to the present modification will be described.

A controller 14 can rotate the first light selection aperture 26 and the second light selection aperture 28 of the present embodiment independently about rotation axes 26a and 28a. This makes it possible to form various blocking regions, red light transmission regions, or blue and red light transmission regions in a region including the imaging optical axis C of a focal plane fs or in the vicinity thereof. That is, it is possible to form various types of light selection regions by adjusting each rotation angle of the blocking portion 62 of the first light selection aperture 26 and the wavelength-selective transmission plate 92 of the second light selection aperture 28.

For example, the first light selection aperture 26 includes the plurality of opening edges 64 as M types (M is a natural number of 2 or more) of light selection regions, and the second light selection aperture 28 includes the plurality of opening edges 94 and the wavelength-selective transmission plate 92 on the outer peripheries of the opening edges 94 as N types (N is a natural number of 2 or more) of light selection regions. At this time, by adjusting the rotation angles of the first light selection aperture 26 and the second light selection aperture 28, at least N× M types of light selection regions can be formed in the region including the imaging optical axis C of the focal plane fs or in the vicinity thereof. On the other hand, only N or M types of light selection regions can be formed in the first light selection aperture 26 or the second light selection aperture 28. That is, according to the present embodiment, there is an advantageous effect that a dramatically increased number of types of light selection regions can be formed.

As the types of formable light selection regions increase, the angular resolution of the acquirable scattering angle distribution improves. Therefore, using the optical inspection apparatus 12 according to the present modification to capture a plurality of images of an object O and processing the images by the controller 14 has an advantageous effect of improving the accuracy of the optical inspection of the object O. Alternatively, using the optical inspection apparatus 12 according to the present modification to increase the types of formable light selection regions has an advantageous effect of further optimizing the light selection regions according to the inspection target.

In the present modification, if the positional relationship between the two light selection apertures 26 and 28 is set as illustrated in FIGS. 16 and 17, for example, the light can be divided into light of two different color regions, that is, a red light transmission region and a blue and red light transmission region. This has an advantageous effect that, when the controller 14 acquires an image by the image sensor 24 of the imaging portion 20, scattering angle distribution information of different angles can be simultaneously distinguished by color. That is, the optical inspection system 10 according to the present embodiment has an advantageous effect of increasing the scattering angle distribution information that can be acquired by one imaging.

If the scattering angle distribution information that can be acquired at one time increases, there is an advantageous effect that the controller 14 can optically inspect the surface state of the object O with higher accuracy. Alternatively, if the scattering angle distribution information that can be acquired at one time increases, there is an advantageous effect that the controller 14 can optically inspect the surface state of the object O at a higher speed.

According to at least one of the embodiments described above, it is possible to provide the optical inspection apparatus 12 capable of acquiring a plurality of images according to the direction of the light beam from the object O, and the optical inspection system 10 including the optical inspection apparatus 12.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An optical inspection apparatus comprising:
an image-forming optical element with an imaging optical axis;
an image sensor having a light-receiving surface intersecting with the imaging optical axis; and
a movable first light selection aperture,
wherein:
the first light selection aperture includes a first light selection region and a second light selection region that selectively pass light in different directions from an object,
the first light selection aperture is arranged on or near a focal plane of the image-forming optical element,
when the first light selection region of the first light selection aperture moves to a position including the imaging optical axis, the image sensor is configured to acquire a first image of the object incident on the light-receiving surface through the image-forming optical element and the first light selection region, and
when the second light selection region of the first light selection aperture moves to a position including the imaging optical axis, the image sensor is configured to acquire a second image of the object incident on the light-receiving surface through the image-forming optical element and the second light selection region.

2. The optical inspection apparatus according to claim 1, further comprising a second light selection aperture that is independently movable relative to the first light selection aperture,
wherein:
the second light selection aperture includes a third light selection region and a fourth light selection region that selectively pass light in different directions from the object,
the second light selection aperture is arranged on or near the focal plane of the image-forming optical element, and
at least one of the first light selection region and the second light selection region of the first light selection aperture and at least one of the third light selection region and the fourth light selection region of the second light selection aperture are both simultaneously movable to positions including the imaging optical axis.

3. The optical inspection apparatus according to claim 2, wherein
when the first light selection region of the first light selection aperture and the third light selection region of the second light selection aperture are both simultaneously moved to positions including the imaging optical axis, the image sensor is configured to acquire a third image of the object incident on the light-receiving surface, and
when the second light selection region of the first light selection aperture and the fourth light selection region of the second light selection aperture are both simultaneously moved to positions including the imaging optical axis, the image sensor is configured to acquire a fourth image of the object incident on the light-receiving surface.

4. The optical inspection apparatus according to claim 2, wherein:
when the first light selection region of the first light selection aperture and the third light selection region of the second light selection aperture are both simultaneously moved to positions including the imaging optical axis, the image sensor is configured to acquire a third image of the object incident on the light-receiving surface, and
when a combination of a light selection region of the first light selection aperture and a light selection region of the second light selection aperture, the combination being different from a combination of the first light selection region and the third light selection region, is simultaneously moved to positions including the imaging optical axis, the image sensor is configured to acquire a fifth image of the object incident on the light-receiving surface.

5. The optical inspection apparatus according to claim 1, wherein
the first light selection aperture includes a light blocking region that blocks at least light and a light transmission region provided in the light blocking region.

6. The optical inspection apparatus according to claim 2, wherein
the second light selection aperture includes a light transmission region that transmits light and a light blocking region that is provided in the light transmission region and blocks at least light.

7. The optical inspection apparatus according to claim 2, wherein
the second light selection aperture has a plurality of transmission wavelength spectrum regions through which light of at least two different wavelengths is transmitted.

8. The optical inspection apparatus according to claim 5, wherein
the light transmission region of the first light selection aperture is formed as a plurality of through-holes, and
each of the through-holes has a taper expanding in a direction away from the image sensor.

9. The optical inspection apparatus according to claim 6, wherein
the light transmission region of the second light selection aperture is formed of a light transmission plate that transmits light, and
the light blocking region of the second light selection aperture is formed by bonding a light blocking substance that blocks light to a surface of the light transmission plate far from the image sensor.

10. The optical inspection apparatus according to claim 2, wherein
the first light selection aperture and the second light selection aperture each have a rotation axis parallel to the imaging optical axis, and is independently movable about the rotation axis.

11. The optical inspection apparatus according to claim 1, further comprising an illumination portion, wherein
the illumination portion is configured to emit parallel illumination along the imaging optical axis toward the object.

12. An optical inspection system comprising:
the optical inspection apparatus according to claim 1; and
a processor that is configured to acquire scattering angle distribution information of the object by using the first image and the second image.

13. An optical inspection system comprising:
the optical inspection apparatus according to claim 1;
an aperture movement mechanism that moves the first light selection aperture; and
a processor that controls the aperture movement mechanism and controls movement of the first light selection aperture.
